(19) United States
(12) Patent Application Publication
(10) Pub. No.: US 2021/0342844 A1
(43) Pub. Date: Nov. 4, 2021

(54) METHODS, APPARATUSES, AND DEVICES FOR VERIFYING AUTHENTICITY OF CROSS-BORDER TRANSACTIONS

(71) Applicant: ALIPAY (HANGZHOU) INFORMATION TECHNOLOGY CO., LTD., Hangzhou (CN)

(72) Inventor: Lei Huang, Hangzhou (CN)

(73) Assignee: ALIPAY (HANGZHOU) INFORMATION TECHNOLOGY CO., LTD., Hangzhou (CN)

(21) Appl. No.: 17/348,073

(22) Filed: Jun. 15, 2021

(30) Foreign Application Priority Data
Aug. 18, 2020 (CN) 202010829781.0

(51) Int. Cl. G06Q 20/40; G06Q 20/38

(52) U.S. Cl. CPC G06Q 20/4015; G06Q 20/405; G06Q 20/381; G06Q 20/3827; G06Q 20/4016

(57) ABSTRACT

Disclosed herein are methods, systems, and media for verifying authenticity of cross-border transactions. One of the methods herein comprises: obtaining transaction information of a transaction submitted by a transaction platform in a blockchain network; obtaining, from the blockchain network, remittance information provided by a payment institution for the transaction, wherein the payment institution is in the blockchain network; generating, based on the transaction information and the remittance information, a first result of authenticity of the transaction; and generating authenticity confirmation of the transaction based on the first result.

### CROSS-REFERENCE TO RELATED APPLICATIONS

This application claims priority to Chinese Patent Application No. 202010829781.0, filed on Aug. 18, 2020, which is hereby incorporated by reference in its entirety.

### TECHNICAL FIELD

The present application relates to the technical fields of blockchain and compliance, and in particular, to methods, apparatuses, and devices for verifying authenticity of cross-border transactions.

### BACKGROUND

In a narrow sense, cross-border trade refers to exchange of goods and services between countries. In a broad sense, cross-border trade further covers an entire process of corresponding cross-border import and export arrangements, cross-border trade models, and cross-border settlements related to the cross-border trade activities. To facilitate cross-border trade, more cross-border e-commerce platforms supporting cross-border trade have emerged. Transactions concluded on the cross-border e-commerce platforms are cross-border transactions. Because buyers and sellers in cross-border transactions are transaction entities of different customs territories, payment of the cross-border transactions involves foreign exchange. Therefore, supervisory authorities have always paid great attention to compliance of the cross-border transactions.

### SUMMARY

Embodiments of the present specification provide methods, apparatuses, and devices for verifying authenticity of cross-border transactions, to alleviate problems of low efficiency and low accuracy of an existing method for verifying authenticity of cross-border transactions.

To alleviate the previous technical problems, the embodiments of the present specification are implemented as follows.

According to a first aspect, the embodiments of the present specification provide a method for verifying authenticity of a cross-border transaction. The method includes the following steps.

Transaction information of a cross-border transaction submitted by a transaction platform is obtained in a blockchain network, where the transaction platform and a payment institution participate in the blockchain network; remittance information submitted by the payment institution for the cross-border transaction is obtained from the blockchain network; whether the cross-border transaction is authentic is determined based on the transaction information and the remittance information, to obtain a first determining result; and when the first determining result is yes, authenticity confirmation information of the cross-border transaction is generated.

According to a second aspect, the embodiments of the present specification provide an apparatus for verifying authenticity of a cross-border transaction. The apparatus includes: a transaction information obtaining module, configured to obtain transaction information of a cross-border transaction submitted by a transaction platform in a blockchain network, where the transaction platform and a payment institution participate in the blockchain network; a remittance information obtaining module, configured to obtain remittance information submitted by the payment institution for the cross-border transaction from the blockchain network; a first determining module, configured to determine, based on the transaction information and the remittance information, whether the cross-border transaction is authentic, to obtain a first determining result; and an authenticity confirmation information generation module, configured to generate authenticity confirmation information of the cross-border transaction when the first determining result is yes.

According to a third aspect, the embodiments of the present specification provide a device for verifying authenticity of a cross-border transaction. The device includes: at least one processor; and a memory communicatively connected to the at least one processor, where the memory stores instructions that can be executed by the at least one processor, and the instructions are executed by the at least one processor, so that the at least one processor can: obtain transaction information of a cross-border transaction submitted by a transaction platform in a blockchain network, where the transaction platform and a payment institution participate in the blockchain network; obtain remittance information submitted by the payment institution for the cross-border transaction from the blockchain network; determine, based on the transaction information and the remittance information, whether the cross-border transaction is authentic, to obtain a first determining result; and generate authenticity confirmation information of the cross-border transaction when the first determining result is yes.

Some embodiments of the present specification provide a computer-readable medium, where the computer-readable medium stores computer-readable instructions, and the computer-readable instructions can be executed by a processor to implement a method for verifying authenticity of a cross-border transaction.

The embodiments of the present specification can achieve the following beneficial effects: A blockchain technology is introduced, so that the transaction platform and the payment institution both participate in the same blockchain. After the transaction is completed, the transaction platform uploads the transaction information to the blockchain. After cross-border remittance is completed, the payment institution uploads the remittance information of the cross-border transaction to the blockchain. A supervision institution can obtain the transaction information and payment information for the cross-border transaction on the blockchain at any time, and verify authenticity. The solution can improve verification efficiency, and improve data security as well.

### BRIEF DESCRIPTION OF DRAWINGS

To describe the technical solutions in the embodiments of the present specification or in the existing technology more clearly, the following briefly describes the accompanying drawings needed for describing the embodiments or the existing technology. Clearly, the accompanying drawings in the following description merely show some embodiments of the present application, and a person of ordinary skill in the art can still derive other drawings from these accompanying drawings without creative efforts.

FIG. 1 is a schematic diagram illustrating a scenario of a method for verifying authenticity of a cross-border transaction, according to some embodiments of the present specification;

FIG. 2 is a schematic flowchart illustrating a method for verifying authenticity of a cross-border transaction, according to some embodiments of the present specification;

FIG. 3 is a schematic structural diagram illustrating an apparatus corresponding to FIG. 2 and used for verifying authenticity of a cross-border transaction, according to some embodiments of the present specification; and

FIG. 4 is a schematic structural diagram illustrating a device corresponding to FIG. 2 and used for verifying authenticity of a cross-border transaction, according to some embodiments of the present specification.

### DESCRIPTION OF EMBODIMENTS

To make the objectives, technical solutions, and advantages of one or more embodiments of the present specification clearer, the following clearly and completely describes the technical solutions in the one or more embodiments of the present specification with reference to specific embodiments of the present specification and corresponding accompanying drawings. Clearly, the described embodiments are merely some rather than all of the embodiments of the present specification. All other embodiments obtained by a person of ordinary skill in the art based on the embodiments of the present specification without creative efforts shall fall within the protection scope of the one or more embodiments of the present specification.

The technical solutions provided in the embodiments of the present specification are described in detail below with reference to the accompanying drawings.

In the existing technology, when a supervisory authority verifies compliance (authenticity and legitimacy) of a cross-border transaction, corresponding data usually needs to be submitted through a cross-border transaction platform and a payment institution (mainly a bank) separately. Therefore, efficiency is low, and authenticity of the data cannot be ensured.

A blockchain network (Block Chain Network) is a new distributed infrastructure and calculation method that uses a blockchain data structure to verify and store data, uses a distributed node consensus algorithm to generate and update data, uses cryptography to ensure security of data transmission and access, and uses a smart contract formed by automated script code to program and operate data. The blockchain network includes a plurality of nodes. When each node broadcasts information or a block to the blockchain network, all the nodes can receive the information or block and verify the received block. When a ratio of a quantity of nodes that successfully verify the block to a total quantity of nodes in the entire blockchain network is greater than a predetermined threshold, it is determined that the block is successfully verified in the blockchain network, and each node receives the block and stores the block in local node space. The nodes can be understood as electronic devices with storage functions, such as servers and terminals. The chain types of the blockchain network mainly include a public chain, a consortium chain, and a private chain.

A blockchain (Block chain) can be understood as a data chain formed by sequential storage of a plurality of blocks. A block header of each block contains a timestamp of the block, a hash value of previous block information, and a hash value of current block information. As such, mutual verification between blocks is achieved, and a non-tamperable blockchain is formed. Each block can be understood as a data block (unit for storing data). As a decentralized database, the blockchain is a series of data blocks that are correlated and generated by using a cryptographic method. Each data block contains information about a network transaction, where the information is used to verify validity of information of the data block (anti-counterfeiting) and generate a next block. The blocks are connected end to end to form a chain, which is referred to as the blockchain. If data in a block needs to be modified, content of all blocks after this block needs to be modified, and data backed up by all nodes in the blockchain network needs to be modified. Therefore, the blockchain has characteristics of being difficult to tamper with and delete. After data is stored on the blockchain, the blockchain serves as a reliable method to maintain content integrity.

The blockchain technology mainly has the following four characteristics.

(1) Decentralization: It can implement a peer-to-peer transaction, coordination, and collaboration without intervention of a third party. In the blockchain network, no institution or individual can control all the data, and when any node stops working, there is no impact on the overall operation of the system. This decentralized network greatly improves data security.

(2) Non-tamperability: The blockchain uses an encryption technology to verify and store data, and uses a distributed consensus algorithm to add and update data. The blockchain requires all nodes to participate in verifying transactions and generating blocks. When any data is modified, all subsequent records need to be changed. Therefore, it is very difficult to modify data of a single node.

(3) Openness, transparency, and traceability: Written block content is replicated to each node, each node has the latest complete database copy, and all record information is public. Any person can query block data through a public interface. Each transaction on the blockchain is persistently stored in block data through chain storage. In addition, concatenated hash (HASH) digest processing is performed on all transaction records of all blocks by using a cryptographic algorithm, so that any historical transaction data can be traced.

(4) Collective maintainability: The decentralization characteristic of the blockchain network determines collective maintainability of the blockchain network. A traditional centralized institution usually needs to play three roles: a data recorder, a data manager, and a data analyst. The blockchain network is jointly maintained by all participants equally. All parties have clear rights and responsibilities, and there is no need to transfer rights to a third-party institution to achieve joint collaboration.

Based on the characteristics of decentralization, non-tamperability, openness, transparency, and traceability of the blockchain, this solution proposes a technical solution that can not only improve verification efficiency, but also ensure data security. The blockchain technology is introduced, so that a transaction platform and a payment institution both participate on the same blockchain. A supervision institution can obtain related data from the blockchain for compliance verification at any time.

This solution can be applied to cross-border e-commerce. The cross-border e-commerce is an international business activity in which transaction entities belonging to different customs territories conclude a transaction through an e-commerce platform, conduct electronic payment settlement, and deliver a product through cross-border e-commerce logistics and off-site warehousing to complete the transaction. The cross-border e-commerce is divided into export cross-border e-commerce and import cross-border e-commerce. The transactions in this solution are mainly import cross-border transactions.

To alleviate disadvantages of the existing technology, this solution provides the following embodiments.

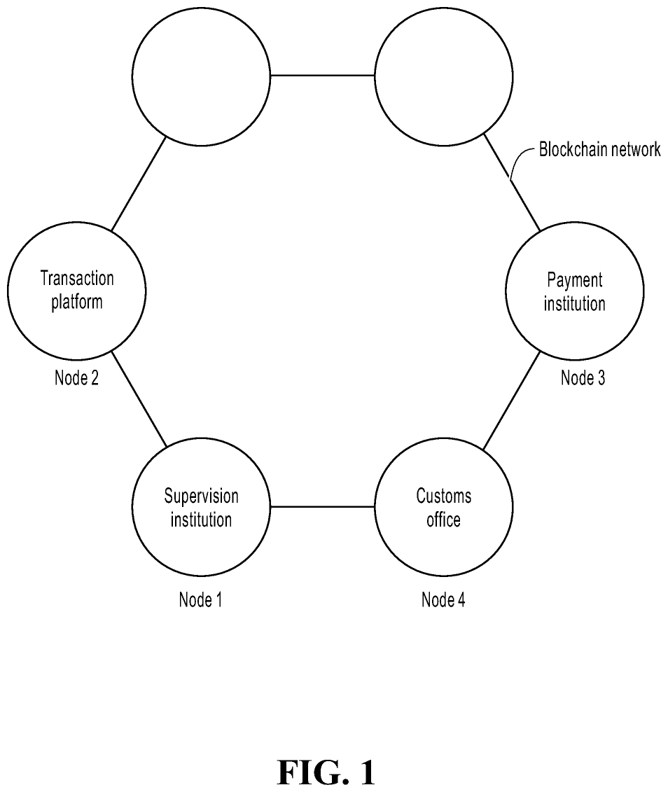

FIG. 1 is a schematic diagram illustrating a scenario of a method for verifying authenticity of a cross-border transaction, according to some embodiments of the present specification. As shown in FIG. 1, users participating in a blockchain network include a supervision institution, a transaction platform, a payment institution, and a customs office. The blockchain network can be a single chain or a plurality of chains. Cross-chain data exchange can be employed in the plurality of chains. The transaction platform can be a cross-border transaction platform, configured to support cross-border trade. The payment institution is a bank.

It is worthwhile to note that the supervision institution may not be a node on the chain, provided that the supervision institution can obtain data stored on the blockchain.

Basic functions of the State Administration of Foreign Exchange include: (1) being responsible for measuring and monitoring the international balance of payments, and external claims and debts, releasing relevant information in accordance with regulations, and undertaking related work of monitoring cross-border capital flows; (2) being responsible for supervision and management of the national foreign exchange market; assuming the responsibility for supervision and management of foreign exchange settlements and sales; and cultivating and developing the foreign exchange market; (3) being responsible for supervising and inspecting authenticity and legitimacy of foreign exchange receipts and payments under current accounts in accordance with the laws; being responsible for implementing capital account foreign exchange management in accordance with the laws, and continuously improving management in accordance with the RMB capital account convertibility process; and regulating domestic and overseas foreign exchange account management; and (4) being responsible for implementing foreign exchange supervision and inspection in accordance with the laws, and penalizing violations of foreign exchange management.

According to the basic functions of the State Administration of Foreign Exchange, the supervision institution can be the State Administration of Foreign Exchange. The State Administration of Foreign Exchange inspects compliance of cross-border transactions.

Next, a method for verifying authenticity of a cross-border transaction according to some embodiments of the present specification is described in detail with the accompanying drawings.

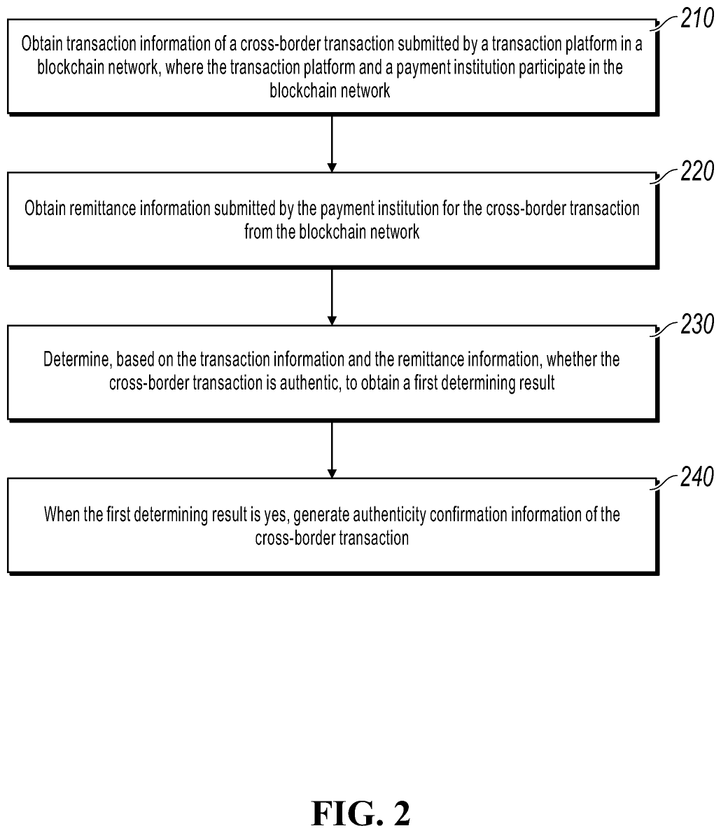

FIG. 2 is a schematic flowchart illustrating a method for verifying authenticity of a cross-border transaction, according to some embodiments of the present specification. From a program perspective, the procedure can be performed by a program installed on an application server or an application client terminal. The method can be performed by a supervision institution, and specifically, the State Administration of Foreign Exchange. A device performing the method can be a server of a platform of the supervision institution, that is, the device obtains data only from a blockchain, and then performs off-chain compliance verification. The device performing the method can also be a server on the chain, and the method can be completed by using a smart contract on the chain.

As shown in FIG. 2, the procedure can include the following steps.

Step 210: Obtain transaction information of a cross-border transaction submitted by a transaction platform in a blockchain network, where the transaction platform and a payment institution participate in the blockchain network.

The transaction platform can store the transaction information on the chain after the transaction information is generated, to prevent tampering.

The transaction information can include transaction order information, payment order information, and logistics order information. The transaction platform can upload the transaction order information, the payment order information, and the logistics order information to the chain simultaneously or separately. Specifically, after a merchant creates a transaction order, the transaction platform uploads the transaction order information to the chain. After a user makes payment, the transaction platform uploads the payment order information to the chain. After a logistics company generates the logistics order information, the transaction platform uploads the logistics order information to the chain.

Each cross-border transaction has a transaction order number, and various types of information of the cross-border transaction can be queried based on the transaction order number.

Step 220: Obtain remittance information submitted by the payment institution for the cross-border transaction from the blockchain network.

For ease of query, data on the blockchain network can be downloaded to a server of the supervision institution, and then corresponding remittance information can be queried based on the order number.

Step 220 can also be performed by setting a program that performs automatic classification based on the transaction order number.

The payment institution here can be a bank, and specifically, can be a bank undertaking overseas remittance.

Step 230: Determine, based on the transaction information and the remittance information, whether the cross-border transaction is authentic, to obtain a first determining result.

Determining whether the cross-border transaction is authentic can be implemented by checking information from different parties. For example, the determining can be performed based on whether payment information of a consumer in the transaction information is consistent with the remittance information. The determining, based on the transaction information and the remittance information, whether the cross-border transaction is authentic can specifically include: determining the payment information of the consumer in the transaction information; and determining whether the payment information is consistent with the remittance information.

The payment information of the consumer is payment information of a buyer buying a cross-border product, and a payment currency is RMB. The remittance information is remittance information of the transaction platform for the cross-border transaction. Because foreign exchange is involved, the remittance information is remittance to be done by a bank. A specific step is that the transaction platform first transfers money to the bank, and then the bank performs cross-border transfer, to facilitate supervision. In this case, the remittance information is remittance information of the bank.

A payment amount paid by the consumer is consistent with a payment amount remitted by the bank, which is a necessary condition for determining that the cross-border transaction is an authentic transaction. Therefore, when determining whether the cross-border transaction is authentic, it is necessary to determine whether the payment amount paid by the consumer is consistent with the payment amount remitted by the bank.

Step 240: When the first determining result is yes, generate authenticity confirmation information of the cross-border transaction.

The authenticity confirmation information can indicate that the transaction information is consistent with the remittance information.

It should be understood that the sequence of some steps of the method in one or more embodiments of the present specification can be interchanged based on actual needs, or some steps can be omitted or deleted.

In the method in FIG. 2, the blockchain technology is introduced, so that the transaction platform and the payment institution both participate in the same blockchain. After the transaction is completed, the transaction platform uploads the transaction information to the blockchain. After cross-border remittance is completed, the payment institution uploads the remittance information of the cross-border transaction to the blockchain. The supervision institution can obtain the transaction information and payment information for the cross-border transaction on the blockchain at any time, and verify authenticity. The solution can not only improve verification efficiency, but also improve data security.

Based on the method in FIG. 2, the embodiments of the present specification further provide some specific implementations of the method, which are described below.

Optionally, the determining whether the payment information is consistent with the remittance information can specifically include: determining a payment amount and a receiving currency of the payment information; determining a remittance amount and a remittance currency of the remittance information; determining whether the receiving currency is consistent with the remittance currency, to obtain a second determining result; and when the second result indicates that the receiving currency is consistent with the remittance currency, determining whether the payment amount is consistent with the remittance amount.

This implementation specifically defines how to determine whether the payment information is consistent with the remittance information. Because conversion between different currencies may be involved, both the payment information and the remittance information are marked with specific currencies. For example, the payment information includes an amount and a currency paid by the consumer, for example, RMB 2000. The corresponding remittance amount also involves a remittance amount and a currency, for example USD 500. When determining whether the payment amount is consistent with the remittance amount, it is necessary to determine whether the receiving currency is consistent with the remittance currency.

The receiving currency can indicate a currency paid by the consumer, and the remittance currency can indicate a currency remitted by the payment institution. It is worthwhile to note that the remittance currency can be the same as the currency of the amount transferred by the transaction platform to the payment institution, for example, crossing-border in the form of RMB, and exchanging abroad; or may be different from the currency of the amount transferred by the transaction platform to the payment institution, for example, exchanging abroad, and crossing border in the form of a foreign currency.

If the receiving currency and the remittance currency are consistent and are both RMB, whether the payment amount is consistent with the remittance amount can be directly determined. If the amounts are consistent, it indicates that the transaction information is consistent with the remittance information and satisfies a requirement on cross-border authenticity. If the amounts are inconsistent, it indicates that the transaction information is inconsistent with the remittance information and does not satisfy the requirement on cross-border authenticity, and is suspected of cross-border transaction forgery.

When the second result indicates that the receiving currency is inconsistent with the remittance currency, an exchange rate of the remittance information on a remittance date is determined based on the receiving currency and the remittance currency; an estimated remittance amount is calculated based on the payment amount and the exchange rate; and whether the estimated remittance amount is consistent with the remittance amount is determined.

If the receiving currency is inconsistent with the remittance currency, further determining is performed based on an exchange rate between different currencies. An exchange rate between currencies is not a fixed value, and changes with time. In this case, when determining the exchange rate between the receiving currency and the remittance currency, it is necessary to first determine the remittance date of the bank, and then query the exchange rate on the remittance date.

In some cases, remittance information includes a remittance date and an exchange rate. An exchange rate can be queried based on a remittance date by official or legal means, and then compared with the exchange rate described in the remittance information to determine whether the exchange rate is correct. Or the queried exchange rate can be directly used as the exchange rate on the remittance date.

In some cases, a general domestic practice is that a payment currency is converted into a remittance currency. The estimated remittance amount can be determined based on the payment amount and the exchange rate; and then whether the estimated remittance amount is consistent with the actual remittance amount (that is, the remittance amount described in the remittance information) is determined.

In some forged cross-border transactions, there are authentic transfer records and remittance records, but there are no authentic transactions of products. In this case, information from other institutions is needed for screening. Specifically, a first supervision institution also participates in the blockchain network, and before the generating authenticity confirmation information of the cross-border transaction, the method can further include: obtaining cross-border cargo declaration information submitted by the first supervision institution in the blockchain network; and determining whether the transaction information is consistent with the cross-border cargo declaration information, to obtain a third determining result; and the generating authenticity confirmation information of the cross-border transaction specifically includes: when the third determining result is yes, generating the authenticity confirmation information of the cross-border transaction.

In this implementation, the first supervision institution is the customs office. The customs office is a state administrative agency that implements functions of import and export supervision and management in accordance with the laws and administrative regulations of the country (or region). One of the responsibilities of the customs office is to supervise and manage imported and exported goods, luggage of passengers, and postal articles, and inbound and outbound transportation vehicles. Some are referred to as customs clearance management, and some are referred to as ensuring the legal entry and exit of goods and products.

When a product is to enter the country, it is necessary to fill in an entry declaration form. If a real cargo enters the country, the customs office keeps a record. Therefore, cargo entry declaration information can also be obtained from the customs office and is compared with transaction product information in the transaction information to determine whether the information is consistent. If the transaction information is consistent with the product information in the cross-border cargo declaration information, it indicates that there is physical trading in the cross-border transaction.

Optionally, the determining whether the transaction information is consistent with the cross-border cargo declaration information can specifically include: determining product information, merchant information, and consumer information of the transaction information; determining enterprise information, cargo information, and consignee information of the cross-border cargo declaration information; and determining whether the product information is consistent with the cargo information, whether the merchant information is consistent with the enterprise information, and whether the consumer information is consistent with the consignee information.

In addition to checking whether the product information is consistent, a better choice can be further checking whether the buyer and seller are consistent with the consigner and consignee. Whether the merchant information is consistent with the enterprise information can mean that the two pieces of information correspond to the same execution body, or two execution bodies where one of the execution bodies is entrusted by the other execution body and can do things on behalf of the other execution body.

Consistency between the product information and the cargo information can mean that the type, quantity, and model of the product are the same.

Consistency between the consumer information and the consignee information can indicate that the two correspond to the same natural person, institution, or legal person.

Optionally, before the generating authenticity confirmation information of the cross-border transaction, the method can further include: (1) determining shareholder information of the merchant information; (2) determining whether a shareholder corresponding to the shareholder information has a close relationship with a consumer corresponding to the consumer information, and if yes, obtaining a quantity of transaction orders between the merchant and the consumer in a predetermined time period; (3) determining whether the quantity of transaction orders is greater than an average order quantity, to obtain a fourth determining result, where the average order quantity indicates an average number of times a consumer makes purchase at the same merchant in the predetermined time period; and (4) when the fourth determining result is yes, determining that the cross-border transaction is an abnormal transaction.

The previous implementation is to verify the authenticity of the cross-border transaction. In addition, it is also necessary to verify legitimacy of the cross-border transaction. Specifically, the legitimacy of the cross-border transaction can be determined based on the relationship between the parties to the transaction.

There is a case in which the two parties to the transaction have a stakeholder relationship and can perform money laundering operations through cross-border transactions or evade taxes or penalties. For this case, the embodiments provide a solution.

The shareholder information of the merchant information is determined. Specifically, shareholder information of an enterprise can be obtained by visiting the website or webpage of the industrial and commercial authority or another authoritative institution.

Whether the shareholder has a close relationship with the consumer is determined. The close relationship can refer to a blood relative, a close friend, or an affiliated enterprise in business. Specifically, the close relationship network of the shareholder can be obtained by collecting a topological map of a family relationship of the shareholder, friend lists on various social platforms, and enterprises with frequent fund transfer in business, etc. Then whether the consumer is a member of a close relationship network of the shareholder is determined.

It is worthwhile to note that, there can be a plurality of shareholders. Therefore, there are also a plurality of close relationship networks.

Cross-border transactions between two parties having a close relationship are not necessarily non-compliant transactions. Therefore, other conditions also need to be set for secondary screening. In this case, it can be determined whether the quantity of transactions between the buyer and the seller having a close relationship exceeds a normal range. The average order quantity indicates an average number of times the consumer makes purchase at the same merchant in the predetermined time period. If the quantity of transactions between the two parties having a close relationship exceeds the average order quantity, it indicates that the transaction has a risk of non-compliance.

It is worthwhile to note that, the average order quantity varies with different types of traded products, and an average order quantity for consumables is greater than an average order quantity for non-consumables. In addition, the average order quantity also varies with the season or special circumstances. Therefore, a plurality of factors should be considered comprehensively when the average order quantity is determined.

Optionally, the method can further include: generating abnormal transaction information for the cross-border transaction; and storing the abnormal transaction information in the blockchain network.

When it is determined that the cross-border transaction is an abnormal transaction, abnormal transaction information can also be generated for the cross-border transaction, and the abnormal transaction information can include why the transaction is determined as an abnormal transaction, the type of the abnormal transaction, and remedial measures. Then the International Administration of Foreign Exchange stores the abnormal transaction information in the blockchain network. Both the transaction platform and the bank can obtain relevant information from the chain. If there is relevant proof information that can be used to eliminate the specific abnormality in the abnormal transaction information, the relevant proof information can also be stored on the chain so that it can be obtained by the International Foreign Exchange Administration for re-verification.

Optionally, before the generating authenticity confirmation information of the cross-border transaction, the method can further include: obtaining orders placed with the merchant corresponding to the merchant information in a predetermined time period; determining a quantity of orders corresponding to a same consumer from the orders; and determining whether a ratio of the order quantity to a quantity of orders placed with the merchant is greater than a predetermined ratio, and if yes, determining that the cross-border transaction is an abnormal transaction.

If the two parties to the transaction do not have a close relationship, but most of consumers in the transaction information corresponding to the merchant are the same consumer, it also indicates that there is illegal behavior such as money laundering. In this case, a total quantity of orders placed with the merchant in the predetermined time period can be obtained, and then a quantity of orders of the same consumer is determined. If the quantity of orders exceeds 50% or even more of the total quantity of orders, it indicates that there is an abnormality in the transaction between the merchant and the consumer.

Optionally, the method can further include: determining an abnormal type of the cross-border transaction; determining a risk label of the merchant based on the abnormal type information; binding the risk label with the merchant; and storing a binding relationship between the risk label and the merchant in the blockchain network.

If it is determined that the cross-border transaction is abnormal, the abnormal type of the cross-border transaction, such as money laundering, unfair competition, or virtual order, can also be determined. Then the risk label of the merchant is determined based on the abnormal type. It is worthwhile to note that, the risk label of the merchant can be consistent with the abnormal type of the cross-border transaction, where consistency can mean “the same,” “similar,” or “related.”

The risk label can be bound with the merchant, and then stored on the server of the supervision institution. When the abnormal transaction is screened, the cross-border transaction can be screened directly based on the risk label. As such, the speed of verification is increased, and efficiency of verification is improved.

In addition, the binding relationship between the risk label and the merchant can also be stored in the blockchain network, so that it can be queried by a plurality of parties.

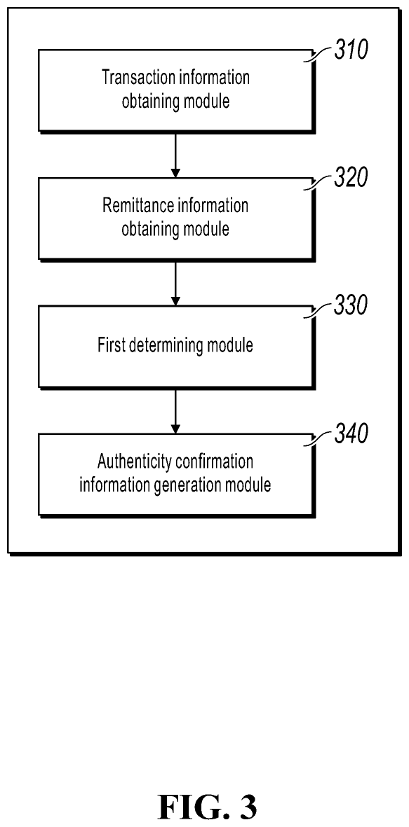

Based on the same idea, the embodiments of the present specification further provide an apparatus corresponding to the previous method. FIG. 3 is a schematic structural diagram illustrating an apparatus corresponding to FIG. 2 and used for verifying authenticity of a cross-border transaction, according to some embodiments of the present specification. As shown in FIG. 3, the apparatus can include: (1) a transaction information obtaining module 310, configured to obtain transaction information of a cross-border transaction submitted by a transaction platform in a blockchain network, where the transaction platform and a payment institution participate in the blockchain network; (2) a remittance information obtaining module 320, configured to obtain remittance information submitted by the payment institution for the cross-border transaction from the blockchain network; (3) a first determining module 330, configured to determine, based on the transaction information and the remittance information, whether the cross-border transaction is authentic, to obtain a first determining result; and (4) an authenticity confirmation information generation module 340, configured to generate authenticity confirmation information of the cross-border transaction when the first determining result is yes.

In the apparatus in FIG. 3, the blockchain technology is introduced, so that the transaction platform and the payment institution both participate in the same blockchain. After the transaction is completed, the transaction platform uploads the transaction information to the blockchain. After cross-border remittance is completed, the payment institution uploads the remittance information of the cross-border transaction to the blockchain. A supervision institution can obtain the transaction information and payment information for the cross-border transaction on the blockchain at any time, and verify authenticity. The solution can not only improve verification efficiency, but also improve data security.

Based on the apparatus in FIG. 3, the embodiments of the present specification further provide some specific implementations of the method, which are described below.

Optionally, the first determining module can specifically include: a payment information determining unit, configured to determine payment information of a consumer in the transaction information; and a first determining unit, configured to determine whether the payment information is consistent with the remittance information.

Optionally, the first determining unit can specifically include: a payment amount and receiving currency determining subunit, configured to determine a payment amount and a receiving currency of the payment information; a remittance amount and remittance currency determining subunit, configured to determine a remittance amount and a remittance currency of the remittance information; a second determining subunit, configured to determine whether the receiving currency is consistent with the remittance currency, to obtain a second determining result; and a third determining subunit, configured to determine whether the payment amount is consistent with the remittance amount when the second result indicates that the receiving currency is consistent with the remittance currency.

Optionally, the first determining unit can further include: an exchange rate determining subunit, configured to determine an exchange rate of the remittance information on a remittance date based on the receiving currency and the remittance currency when the second result indicates that the receiving currency is inconsistent with the remittance currency; an estimated remittance amount calculation subunit, configured to calculate an estimated remittance amount based on the payment amount and the exchange rate; and a first determining subunit, configured to determine whether the estimated remittance amount is consistent with the remittance amount.

Optionally, a first supervision institution also participates in the blockchain network, and the apparatus further includes: a cross-border cargo declaration information obtaining module, configured to obtain cross-border cargo declaration information submitted by the first supervision institution in the blockchain network; and a third determining module, configured to determine whether the transaction information is consistent with the cross-border cargo declaration information, to obtain a third determining result, where the authenticity confirmation information generation module is specifically configured to generate the authenticity confirmation information of the cross-border transaction when the first determining result is yes and the third determining result is yes.

Optionally, the third determining module can specifically include: a product information, merchant information, and consumer information determining unit, configured to determine product information, merchant information, and consumer information of the transaction information; an enterprise information, cargo information, and consignee information determining unit, configured to determine enterprise information, cargo information, and consignee information of the cross-border cargo declaration information; and a third determining unit, configured to determine whether the product information is consistent with the cargo information, whether the merchant information is consistent with the enterprise information, and whether the consumer information is consistent with the consignee information.

Optionally, the apparatus can further include: a shareholder information determining module, configured to determine shareholder information of the merchant information; a transaction order quantity obtaining module, configured to determine whether a shareholder corresponding to the shareholder information has close relationship with a consumer corresponding to the consumer information, and if yes, obtain a quantity of transaction orders between the merchant and the consumer in a predetermined time period; a fourth determining module, configured to determine whether the quantity of transaction orders is greater than an average order quantity, to obtain a fourth determining result, where the average order quantity indicates an average number of times a consumer makes purchase at the same merchant in the predetermined time period; and a first abnormal transaction determining module, configured to determine that the cross-border transaction is an abnormal transaction when the fourth determining result is yes.

Optionally, the apparatus can further include: an abnormal transaction information generation module, configured to generate abnormal transaction information for the cross-border transaction; and an abnormal transaction information storage module, configured to store the abnormal transaction information in the blockchain network.

Optionally, the apparatus can further include: a merchant order obtaining module, configured to obtain orders placed with a merchant corresponding to the merchant information in a predetermined time period; an order quantity determining module, configured to determine a quantity of orders corresponding to a same consumer from the orders; and a second abnormal transaction determining module, configured to determine whether a ratio of the order quantity to a quantity of orders placed with the merchant is greater than a predetermined ratio, and if yes, determine that the cross-border transaction is an abnormal transaction.

Optionally, the apparatus can further include: an abnormal type determining module, configured to determine an abnormal type of the cross-border transaction; a risk label determining module, configured to determine a risk label of the merchant based on the abnormal type information; a binding module, configured to bind the risk label with the merchant; and a binding relationship storage module, configured to store a binding relationship between the risk label and the merchant in the blockchain network.

Based on the same idea, the embodiments of the present specification further provide a device corresponding to the previous methods.

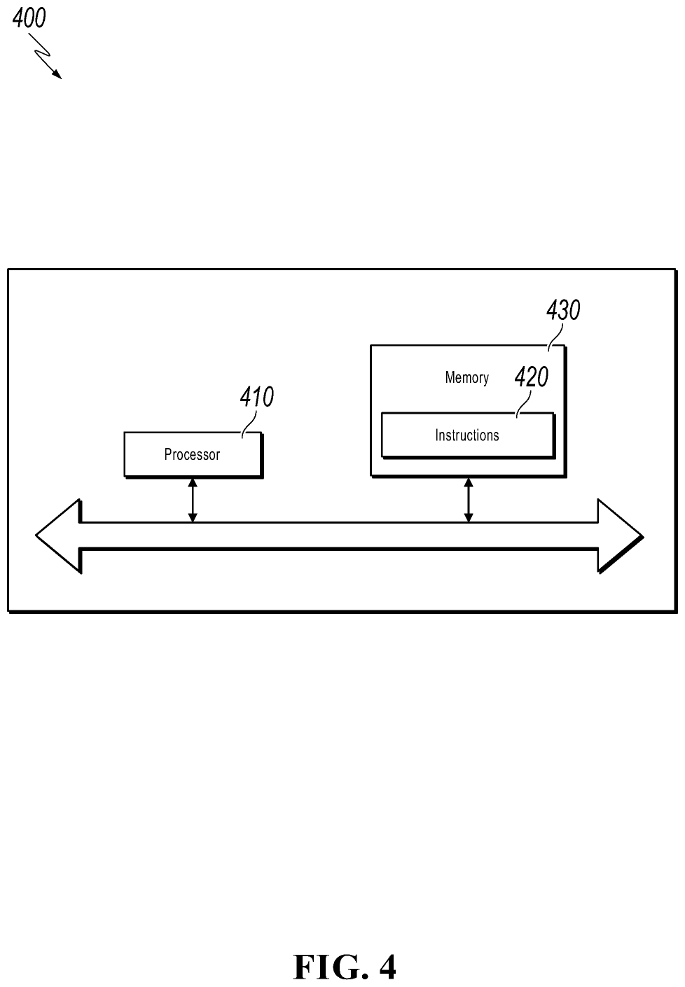

FIG. 4 is a schematic structural diagram illustrating a device corresponding to FIG. 2 and used for verifying authenticity of a cross-border transaction, according to some embodiments of the present specification. As shown in FIG. 4, the device 400 can include: at least one processor 410; and a memory 430 communicatively connected to the at least one processor.

The memory 430 stores instructions 420 that can be executed by the at least one processor 410, and the instructions 420 are executed by the at least one processor 410, so that the at least one processor 410 can: (1) obtain transaction information of a cross-border transaction submitted by a transaction platform in a blockchain network, where the transaction platform and a payment institution participate in the blockchain network; (2) obtain remittance information submitted by the payment institution for the cross-border transaction from the blockchain network; (3) determine, based on the transaction information and the remittance information, whether the cross-border transaction is authentic, to obtain a first determining result; and (4) when the first determining result is yes, generate authenticity confirmation information of the cross-border transaction.

Based on the same idea, the embodiments of the present specification further provide a computer-readable medium. The computer-readable medium stores computer-readable instructions, and the computer-readable instructions can be executed by a processor to implement the following method: obtaining transaction information of a cross-border transaction submitted by a transaction platform in a blockchain network, where the transaction platform and a payment institution participate in the blockchain network; obtaining remittance information submitted by the payment institution for the cross-border transaction from the blockchain network; determining, based on the transaction information and the remittance information, whether the cross-border transaction is authentic, to obtain a first determining result; and when the first determining result is yes, generating authenticity confirmation information of the cross-border transaction.

The embodiments in the present specification are described in a progressive way. For same or similar parts of the embodiments, mutual references can be made. Each embodiment focuses on a difference from other embodiments. Particularly, the device for verifying authenticity of a cross-border transaction, as shown in FIG. 4, is similar to the method embodiments, and therefore is described briefly. For related parts, references can be made to related descriptions in the method embodiments.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, a current improvement for many method procedures can be considered as a direct improvement of a hardware circuit structure. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming autonomously to “integrate” a digital system into a PLD. There is no need to ask a chip manufacturer to design and manufacture a dedicated integrated circuit chip. Moreover, nowadays, manual manufacturing of integrated circuit chips is being replaced. Such programming is also mostly implemented by using “logic compiler (logic compiler)” software instead. The software is similar to a software compiler used to develop and compile a program. However, before compilation, original code also needs to be compiled in a particular programming language. The language is referred to as a hardware description language (HDL). There are many HDLs, such as the Advanced Boolean Expression Language (ABEL), the Altera hardware description language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be in the form of a microprocessor or a processor, or a computer-readable medium that stores computer-readable program code (such as software or firmware) that can be executed by the microprocessor or the processor, a logic gate, a switch, an application specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. A memory controller can also be implemented as a part of the control logic of the memory. A person skilled in the art also knows that, in addition to implementing the controller by using the computer-readable program code, logic programming can be performed on method steps to allow the controller to implement the same function in forms of the logic gate, the switch, the ASIC, the programmable logic controller, and the embedded microprocessor. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit described in the previous embodiments can be implemented by a computer chip or an entity, or implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email receiving and sending device, a game console, a tablet computer, a wearable device, or any combination of these devices.

For ease of description, the apparatus above is described by dividing functions into various units. Certainly, when the present application is implemented, a function of each unit can be implemented in one or more pieces of software and/or hardware.

A person skilled in the art should understand that an embodiment of the present invention can be provided as a method, a system, or a computer program product. Therefore, the present invention can use a form of hardware only embodiments, software only embodiments, or embodiments with a combination of software and hardware. Moreover, the present invention can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on the embodiments of the present specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so that the instructions stored in the computer-readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be a computer-readable instruction, a data structure, a program module, or other data. Examples of the computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. Based on the definition in the present specification, the computer-readable medium does not include transitory media such as a modulated data signal and carrier.

It is also worthwhile to note that the terms “include”, “contain”, or their any other variants are intended to cover a non-exclusive inclusion, so that a process, a method, a product, or a device that includes a list of elements not only includes those elements but also includes other elements not expressly listed, or further includes elements inherent to such process, method, product, or device. Without more constraints, an element preceded by “includes a” does not preclude the existence of additional identical elements in the process, method, product or device that includes the element.

A person skilled in the art should understand that an embodiment of the present application can be provided as a method, a system, or a computer program product. Therefore, the present application can use a form of hardware only embodiments, software only embodiments, or embodiments with a combination of software and hardware. Moreover, the present application can use a form of a computer program product that is implemented on one or more computer-usable storage media (including but not limited to a disk memory, a CD-ROM, an optical memory, etc.) that include computer-usable program code.

The present application can be described in the general context of computer-executable instructions, for example, a program module. Generally, the program module includes a routine, a program, an object, a component, a data structure, etc. executing a specific task or implementing a specific abstract data type. The present application can alternatively be practiced in distributed computing environments in which tasks are performed by remote processing devices that are connected through a communications network. In the distributed computing environment, the program module can be located in both local and remote computer storage media including storage devices.

The previous descriptions are merely embodiments of the present application, and are not intended to limit the present application. A person skilled in the art can make various modifications and changes to the present application. Any modification, equivalent replacement, or improvement made without departing from the spirit and principle of the present application shall fall within the scope of the claims in the present application.

What is claimed is:

1. A computer-implemented method for verifying authenticity of cross-border transactions, comprising:
obtaining transaction information of a transaction submitted by a transaction platform in a blockchain network;
obtaining, from the blockchain network, remittance information provided by a payment institution for the transaction, wherein the payment institution is in the blockchain network;
generating, based on the transaction information and the remittance information, a first result of authenticity of the transaction; and
generating authenticity confirmation of the transaction based on the first result.

2. The computer-implemented method according to claim 1, wherein generating, based on the transaction information and the remittance information, the first result of authenticity of the transaction comprises:
determining payment information of a consumer in the transaction information; and
determining consistency of the payment information with the remittance information.

3. The computer-implemented method according to claim 2, wherein determining consistency of the payment information with the remittance information comprises:
determining a payment amount and a receiving currency of the payment information;
determining a remittance amount and a remittance currency of the remittance information;
generating a second result based on determining the consistency of the receiving currency with the remittance currency; and
determining whether the payment amount is consistent with the remittance amount, based on the second result.

4. The computer-implemented method according to claim 3, wherein the method further comprises:
in response to determining that the receiving currency is inconsistent with the remittance currency, determining an exchange rate for the receiving currency and the remittance currency, wherein the exchange rate is associated with a remittance date included in the remittance information;
calculating an estimated remittance amount based on the payment amount and the exchange rate; and
determining whether the estimated remittance amount is consistent with the remittance amount.

5. The computer-implemented method according to claim 1, wherein, the method further comprises, before generating the authenticity confirmation of the transaction:
obtaining cross-border cargo declaration information submitted by a supervision institution that is in the blockchain network; and
determining whether the transaction information is consistent with the cross-border cargo declaration information in order to obtain a third result,
wherein generating the authenticity confirmation of the transaction comprises generating the authenticity confirmation of the transaction based on the third result.

6. The computer-implemented method according to claim 5, wherein determining whether the transaction information is consistent with the cross-border cargo declaration information comprises:
determining product information, merchant information, and consumer information of the transaction information;
determining enterprise information, cargo information, and consignee information of the cross-border cargo declaration information; and
determining whether the product information is consistent with the cargo information, whether the merchant information is consistent with the enterprise information, and whether the consumer information is consistent with the consignee information.

7. The computer-implemented method according to claim 6, wherein the method further comprises, before generating the authenticity confirmation of the transaction:
determining shareholder information from the merchant information;
in response to determining that a shareholder in the shareholder information has a relationship with a consumer in the consumer information, obtaining a quantity of orders between the merchant and the consumer in a predetermined time period;
generating a fourth result based on comparison of the quantity of orders with an average quantity; and
determining that the transaction is abnormal based on the fourth result.

8. The computer-implemented method according to claim 7, further comprising:
generating abnormal transaction information for the transaction; and
storing the abnormal transaction information in the blockchain network.

9. The computer-implemented method according to claim 6, wherein the method further comprises, before generating the authenticity confirmation of the transaction:
obtaining a total number of orders placed with a merchant in the merchant information in a predetermined time period;
determining a quantity of orders corresponding to a same consumer based on the total number of orders placed with the merchant; and
in response to determining a ratio of the quantity of orders corresponding to the same consumer and the total number of orders placed with the merchant is greater than a predetermined ratio, determining that the transaction is abnormal.

10. The computer-implemented method according to claim 9 further comprising:
determining a risk label of the merchant based on a type of the transaction;
associating the risk label with the merchant; and
storing the association between the risk label and the merchant in the blockchain network.

11. A non-transitory, computer-readable medium storing one or more instructions executable by a computer system to perform operations for verifying authenticity cross-border transactions, comprising:
obtaining transaction information of a transaction submitted by a transaction platform in a blockchain network;
obtaining, from the blockchain network, remittance information provided by a payment institution for the transaction, wherein the payment institution is in the blockchain network;
generating, based on the transaction information and the remittance information, a first result of authenticity of the transaction; and
generating authenticity confirmation of the transaction based on the first result.

12. The non-transitory, computer-readable medium according to claim 11, wherein generating, based on the transaction information and the remittance information, the first result of authenticity of the transaction comprises:
determining payment information of a consumer in the transaction information; and
determining consistency of the payment information with the remittance information.

13. The non-transitory, computer-readable medium according to claim 12, wherein determining consistency of the payment information with the remittance information comprises:
determining a payment amount and a receiving currency of the payment information;
determining a remittance amount and a remittance currency of the remittance information;
generating a second result based on determining the consistency of the receiving currency with the remittance currency; and
determining whether the payment amount is consistent with the remittance amount, based on the second result.

14. The non-transitory, computer-readable medium according to claim 13, wherein the operations further comprises:
in response to determining that the receiving currency is inconsistent with the remittance currency, determining an exchange rate for the receiving currency and the remittance currency, wherein the exchange rate is associated with a remittance date included in the remittance information;
calculating an estimated remittance amount based on the payment amount and the exchange rate; and
determining whether the estimated remittance amount is consistent with the remittance amount.

15. The non-transitory, computer-readable medium according to claim 11, wherein, the operations further comprises, before generating the authenticity confirmation of the transaction:
obtaining cross-border cargo declaration information submitted by a supervision institution that is in the blockchain network; and
determining whether the transaction information is consistent with the cross-border cargo declaration information in order to obtain a third result,
wherein generating the authenticity confirmation of the transaction comprises generating the authenticity confirmation of the transaction based on the third result.

16. The non-transitory, computer-readable medium according to claim 15, wherein determining whether the transaction information is consistent with the cross-border cargo declaration information comprises:
determining product information, merchant information, and consumer information of the transaction information;
determining enterprise information, cargo information, and consignee information of the cross-border cargo declaration information; and
determining whether the product information is consistent with the cargo information, whether the merchant information is consistent with the enterprise information, and whether the consumer information is consistent with the consignee information.

17. The non-transitory, computer-readable medium according to claim 16, wherein the operations further comprises, before generating the authenticity confirmation of the transaction:
determining shareholder information from the merchant information;
in response to determining that a shareholder in the shareholder information has a relationship with a consumer in the consumer information, obtaining a quantity of orders between the merchant and the consumer in a predetermined time period;
generating a fourth result based on comparison of the quantity of orders with an average quantity; and
determining that the transaction is abnormal based on the fourth result.

18. The non-transitory, computer-readable medium according to claim 17, wherein the operations further comprising:
generating abnormal transaction information for the transaction; and
storing the abnormal transaction information in the blockchain network.

19. The non-transitory, computer-readable medium according to claim 16, wherein the operations further comprises, before generating the authenticity confirmation of the transaction:
obtaining a total number of orders placed with a merchant in the merchant information in a predetermined time period;
determining a quantity of orders corresponding to a same consumer based on the total number of orders placed with the merchant; and
in response to determining a ratio of the quantity of orders corresponding to the same consumer and the total number of orders placed with the merchant is greater than a predetermined ratio, determining that the transaction is abnormal.

20. A computer-implemented system for verifying authenticity of cross-border transactions, comprising:
one or more computers; and
one or more computer memory devices interoperably coupled with the one or more computers and having tangible, non-transitory, computer-readable media storing one or more instructions that, when executed by the one or more computers, perform one or more operations comprising:
obtaining transaction information of a transaction submitted by a transaction platform in a blockchain network;
obtaining, from the blockchain network, remittance information provided by a payment institution for the transaction, wherein the payment institution is in the blockchain network;
generating, based on the transaction information and the remittance information, a first result of authenticity of the transaction; and
generating authenticity confirmation of the transaction based on the first result.
